(19) United States
(12) Patent Application Publication
(10) Pub. No.: US 2005/0032472 A1
(43) Pub. Date: Feb. 10, 2005

(54) Method and apparatus of estimating non-linear amplifier response in an overlaid communication system

(76) Inventors: Yimin Jiang, Rockville, MD (US); Feng-Wen Sun, Germantown, MD (US)

Correspondence Address: Hughes Electronics Corporation;Patent Docket Administration, Bldg. 1, Mail Stop A109, P.O. Box 956, El Segundo, CA, 90245-0956, US

(21) Appl. No.: 10/637,225

(22) Filed: Aug. 8, 2003

(51) Int. Cl. H04B 7/185; H04B 1/04

(52) U.S. Cl. 455/13.4; 455/115.1; 455/126

(57) ABSTRACT

An approach is provided estimating non-linear characteristics of an amplifier (such as a Travelling Wave Tube Amplifier) used to amplify a composite signal in a radio communication system. The composite signal, which includes a plurality of inbound signals overlay on an outbound signal, is sampled. The outbound signal is utilized as a training signal. Coarse estimates of the response of the amplifier is generated based on the samples of the composite signal and the training signal. Further, the interference associated with the inbound signals are removed from the estimation of the response of the amplifier by curve-fitting and estimating interference characteristics of the composite signal. An estimated response of the amplifier is thus output, and can be utilized to provide accurate non-linearity compensation and cancellation.

### FIELD OF THE INVENTION

The present invention relates to a communications system, and more particularly to estimating amplifier response in a radio communication system.

### BACKGROUND OF THE INVENTION

Modern radio communication systems, such as satellite networks, provide a pervasive and reliable infrastructure to distribute voice, data, and video signals for global exchange and broadcast of information. These radio communication systems have emerged as a viable option to terrestrial communication systems. Satellite communication systems are susceptible to service disruptions stemming from changing channel conditions, such as fading because of weather disturbances. Additionally, such systems cannot readily increase capacity as the number of satellite transponders is fixed. Channel interference also constrains the system capacity. Further, these satellite transponders introduce non-linear behavior of the communication channels by utilizing non-linear high power amplifiers. This non-linear behavior compounds the channel interference. As a result, spectral efficiency is reduced.

FIG. 20 is a diagram of a conventional satellite system in which inbound and outbound signals utilize unique frequency assignments. A two-way satellite system 2000 includes a hub station 2001 that transmits outbound signals to a satellite 2003 over a first carrier frequency, f₁, and receives inbound signals from the satellite 2003 over a second carrier frequency, f₂. As used herein, the terms “inbound” and “inroute” are used synonymously to refer to a satellite channel supporting communication into the hub station 2001, while the terms “outbound” and “outroute” are used interchangeably to refer to a satellite channel transporting traffic out from the hub station 2001. Concurrently, the satellite 2003 can communicate with a remote satellite terminal 2005, which utilizes two other frequencies, f₃, and f₄, to transmit and receive, respectively. This arrangement is typical of a two-way satellite communication system, whereby the hub station 2001 transmits content to multiple Very Small Aperture Terminals (VSATs) 2005 (in which one is shown). The use of unique frequencies by the terminal 2005 and the hub station 2001 ensures that channel interference is minimized. The drawback, however, is that a large number of frequencies are required when terminals are added to the system 2000. As spectrum is a precious resource, it is vital to use the spectrum efficiently.

An improvement to the system 2000 requires sharing of the satellite transponder for the inbound signals and the outbound signals. The efficiency of the spectrum sharing can be measured in the total throughput achieved by the inroute and outroute. Alternatively, if the outbound throughput is maintained at the same level as that of system without sharing the spectrum with the inroutes, the throughput achieved by the inbounds are gained by the system. Different schemes will yield different gains. In particular, when compared with traditional systems, significant gain can be realized by properly modeling and compensating the impact of the transmission channel. Conventional approaches assume that both inbounds and outbound share an ideal linear channel; however, because Travelling Wave Tube Amplifiers (TWTAs) are used, this assumption is problematic. As a result of this assumption, large uncompensated mutual interference exists between the inbound signals and the outbound signals.

Conventionally, the use of guard bands is widely adopted in satellite communications to mitigate inter-channel interference. It is noted that if the inter-channel interference can be effectively suppressed, the guard band can be reduced, thus the radio spectral efficiency can be improved.

Spread spectrum techniques have also been utilized to curb mutual interference, wherein the average energy of the inbound signal is spread over a bandwidth that is much wider than the information bandwidth. Using spread spectrum transmission in the same transponder for both the inbound and outbound signals conserves space segment resources. However, transmitted power levels must be very low in order to minimize interference to the forward link; and as a result, spread spectrum techniques results in very limited capacity of each link, such that information bit rates on the return links tend to be low.

Furthermore, spread spectrum inbound signals are deployed to combat the channel impairments. A drawback with this approach is that overall system capacity is reduced. In addition, the impairments are greater if the inbound signals are Time Division Multiple Access (TDMA)-based instead of Code Division Multiple Access (CDMA)-based. In particular, it is recognized that the communication channels within the system 2000 may exhibit non-linear characteristics, notably from the amplifiers within the transponders.

High power communication satellites use travelling wave tube amplifiers (TWTA) to amplify signals from ground stations. TWTA exhibits severe non-linearity when operating close to its saturation point, with its response drifting continually due to environment change. Conventional systems fail to compensate for this non-linear behavior. Further, the transponder introduces group delay stemming from a noise-limiting filter applied before the amplifier. Therefore, it is important to timely determine or predict the TWTA non-linear response if accurate interference suppression is to be achieved.

Traditionally, to measure TWTA non-linear response, a continuous wave (CW) signal is employed as the training signal, in which vector network analyzers are used to sweep the TWTA under test in a lab environment. In order to emulate nonconstant envelope modulations (e.g., Quadrature Amplitude Modulation (QAM), Orthogonal Frequency Division Multiplexing (OFDM), etc.), two adjacent tones are used as the input training signals; and the TWTA response is calculated based on the measurements collected by power meters and spectrum analyzers, the intermodulation analysis and some approximations. This approach has a number of drawbacks. One drawback is that to track the real-time response, the TWTAs need to be constantly swept with the CW signals, which consume extra transmission bandwidth. Another drawback concerns the lack of robustness of the uplink interference and noise. One approach to addressing this drawback is to use two tones as training signal, along with spectrum analyzers as the test equipment. Unfortunately, due to the limitation of existing test equipment, this two tone scheme is conducted in the frequency domain based on some coarse approximations, and thus, lacks sufficient accuracy.

The non-linear effects and the group delay impede performance of a shared transponder scheme. It is noted that, in general, a number of techniques exist for compensating non-linear effects of an amplifier. However, conventional techniques are not applicable to spectrum sharing. In the spectrum sharing situation, the impact of these channel impairment exhibits completely different behaviors. Such channel impairment needs to be compensated before the interference suppression techniques can be applied.

Based on the foregoing, there is a need for a radio communication system that enhances system capacity. There is also a need to minimize the effects of non-linearity of the communications channel. Moreover, an approach for providing real-time accurate estimation of TWTA response is desired to support spectrum-efficient multiuser satellite communication systems.

### SUMMARY OF THE INVENTION

These and other needs are addressed by the present invention, wherein an approach is provided for estimating a Travelling Wave Tube Amplifier (TWTA) real-time response for multiuser satellite communication systems that experience uplink noise, downlink noise, and severe interference from the ground stations (e.g., remote terminals). The approach uses an iterative curve-fitting algorithm based on the time-domain coarse estimates of TWTA response to remove the bias caused by the uplink interference. The estimates of the TWTA response can be feed to a non-linearity (or interference) compensation or cancellation module to accurately reconstruct the received signals. This approach advantageously provides accurate estimation of the amplifier response, even with large uplink interference. Additionally, the approach advantageously does not require additional training signals, thereby promoting efficient use of precious bandwidth.

According to one aspect of an embodiment of the present invention, a method of estimating non-linear characteristics of an amplifier used to amplify a composite signal in a radio communication system is disclosed. The method includes sampling the composite signal that includes a plurality of inbound signals overlay on an outbound signal, wherein the outbound signal is utilized as a training signal. The method also includes generating coarse estimates of response of the amplifier based on the samples of the composite signal and the training signal. Further, the method includes removing interference associated with the plurality of inbound signals from the estimation of the response of the amplifier by curve-fitting and estimating interference characteristics of the composite signal; and outputting an estimated response of the amplifier.

According to another aspect of an embodiment of the present invention, an apparatus for estimating non-linear characteristics of an amplifier operating in a radio communication system is disclosed. The apparatus includes means for sampling a composite signal that includes a plurality of inbound signals overlay on an outbound signal, wherein the outbound signal is utilized as a training signal. The apparatus also includes means for generating coarse estimates of response of the amplifier based on the samples of the composite signal and the training signal. Further, the apparatus includes means for removing interference associated with the plurality of inbound signals from the estimation of the response of the amplifier by curve-fitting and estimating interference characteristics of the composite signal; and means for outputting an estimated response of the amplifier.

In yet another aspect of an embodiment of the present invention, a method of compensating for amplifier non-linearity in a radio communication system is disclosed. The method includes estimating distortion characteristics of an amplifier in real-time based on samples of a received composite signal and a training signal, wherein the composite signal includes a plurality of inbound signals overlay on an outbound signal that is utilized as the training signal. The method also includes iteratively curve-fitting to remove uplink interference and downlink interference from the estimates; and modifying the received composite signal based on the estimates.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a radio communication system capable of relaying signals using an overlay of an inbound signal with an outbound signal, according to an embodiment of the present invention;

FIGS. 2A and 2B are graphs showing exemplary non-linear characteristics of an amplifier used in the system of FIG. 1;

FIG. 3 is a diagram of the spectrum of an outbound signal overlaid onto inbound signals, according to an embodiment of the present invention;

FIGS. 4 and 5 are graphs, respectively, of AM/AM and AM/PM responses of an exemplary Travelling wave-Tube Amplifier (TWTA), according to an embodiment of the present invention;

FIG. 6 is a graph of the coefficients of the uplink interference and the downlink noise versus the normalized input power, according to an embodiment of the present invention;

FIG. 7 is a diagram of a transceiver circuitry for providing TWTA response estimation utilized in the system of FIG. 1;

FIG. 8 is a diagram of an exemplary filter used in the TWTA response estimation circuit of FIG. 7;

FIG. 9 is a flowchart of the operation of the TWTA response estimation circuit of FIG. 7;

FIG. 10 is a flowchart of the coarse estimation stage of the process of FIG. 9;

FIGS. 11 and 12 are flowcharts of the post processing stage of the process of FIG. 9;

FIGS. 13, 14A and 14B are graphs of simulation results of the estimated response of the TWTA using various algorithms, according to an embodiment of the present invention;

FIG. 15 is a graph of the Signal-to-Noise Ratio (SNR) for the TWTA output versus uplink multiuser interference;

FIG. 16 is a graph of the Signal-to-Noise Ratio (SNR) for the TWTA output versus the downlink SNR;

FIG. 17 is a graph of the Signal-to-Noise Ratio (SNR) for the TWTA output versus TWTA input backoff;

FIG. 18 is a diagram of a non-linearity compensation and cancellation circuitry that employs the TWTA response estimates output from the TWTA response estimation circuit of FIG. 7, according to an embodiment of the present invention;

FIG. 19 is a diagram of a computer system that can perform the TWTA response estimation, in accordance with an embodiment of the present invention; and

FIG. 20 is a diagram of a conventional satellite system in which inbound and outbound signals utilize unique frequency assignments.

### DESCRIPTION OF THE PREFERRED EMBODIMENT

A method, apparatus, and software for estimating non-linear characteristics of an amplifier used to amplify a composite signal in a radio communication system, are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

Although embodiments of the present invention are explained with respect to a satellite communication system, it is recognized that the present invention can be practiced in any type of radio communication system, including a microwave systems, cellular systems, packet radio networks, etc.

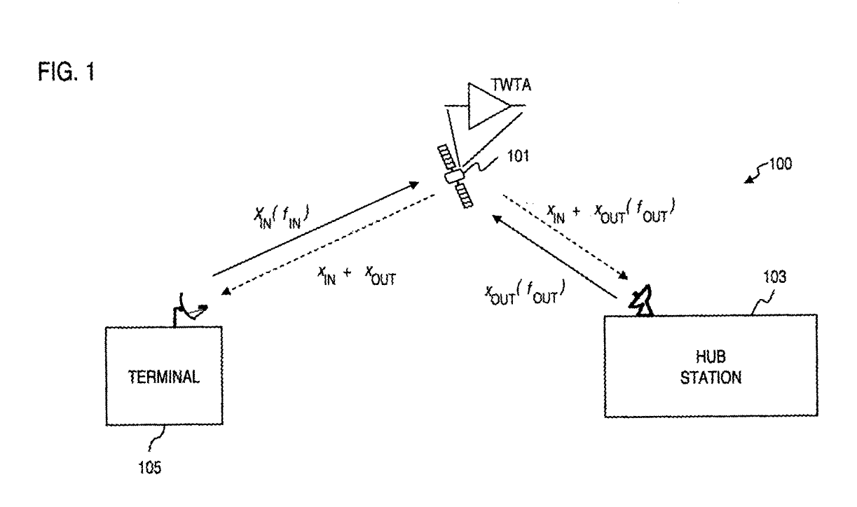

FIG. 1 is a diagram of a radio communication system capable of relaying signals using an overlay of an inbound signal (i.e., inroute) with an outbound signal (i.e, outroute), according to an embodiment of the present invention. A radio communication system 100 includes a relay station (e.g., repeater) 101 for relaying signals from a hub station 103 to a terminal 105 (i.e., outbound or outroute signals) and signals from the terminal 105 to the hub station 103 (i.e., inbound or inbound signals) for supporting two-way communication. In an exemplary embodiment, the relay station 101 is a satellite with multiple transponders, and the terminal 105 is a Very Small Aperture Terminal (VSAT) in support of data communication services.

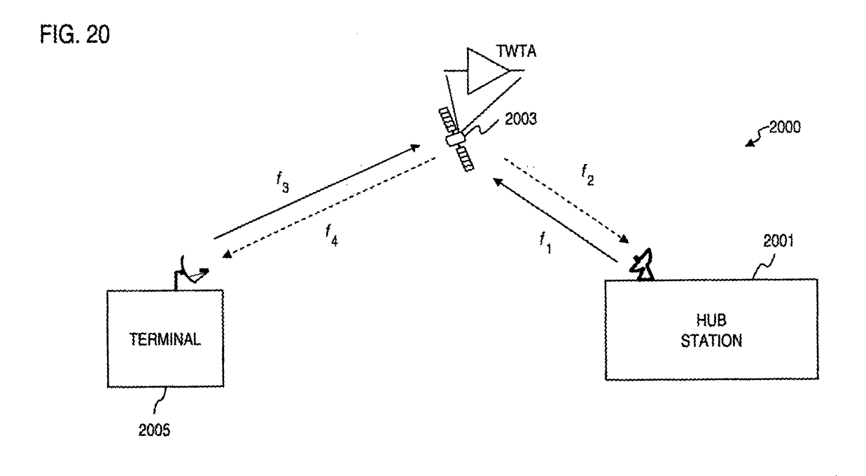

Unlike the conventional system of FIG. 20, the system 100 employs fewer frequencies to communicate between the terminal 105 and the hub station 103. As shown, the hub station 103 transmits outbound signals at frequency, f_{OUT}; likewise, the terminal 105 sends inbound signals at frequency f_{IN}. The inbound frequency f_{IN} is entirely or substantially overlapped with the outbound frequency f_{OUT}. Therefore, f_{IN} effectively reuses the outbound frequency. The relay station 101 forwards a composite (or overlaid) signal that includes an overlay of the inbound signal and the outbound signal to both the hub station 103 and the terminal 105 at the same frequency f_{C}. Typically, the hub station 103 sends a relatively wide band signal to the relay station 101.

The hub station 103 may send a relatively wide band signal to the relay station 101 (e.g., repeater) that further relays the signal to multiple terminals—only one of which is shown (terminal 105). The terminal 105 can send its own signals (i.e., inbound signals) to another repeater (not shown), or the same repeater 101 at a different part of the frequency band; and the repeater 101 relays the signal back to the hub station 103. As noted, the repeater 101 can be a satellite transponder.

In the system 100, the capabilities of the hub station 103 and the remote terminals 105 can be quite different. For instance, the transmission power and the antenna sizes of the remote stations 105 can be far less capable than those of the hub station 103, as to minimize the overall network cost.

The performance of the inbound signals from the terminal 105 depends, in part, on the extent to which the outbound interference can be cancelled. In practical systems, the outbound signal can be hundreds or even thousands times stronger than the inbound signals. Therefore, even if large percentage (e.g., 99%) of the outbound signal can be cancelled, the inbound signal can still experience significant amount of residual interference. Such residual interference can degrade the performance of the inbound signals significantly or limit their throughput. Accurate interference cancellation depends critically on how the channel impairments are being compensated. A dominant cause of impairments is the non-linearity of the channel, which may stem from the non-linear behavior of the satellite transponder.

The system 100 improves efficiency of spectral utilization by exploiting the spectral configuration of the inbound signals as well as the power difference between the inbound signals and the outbound signal. This difference in power is sufficiently large such that the interference by the inbound signals to the outbound signal is assumed to be negligible. As a result, the interference caused by the remote terminals to the outbound signal is very small. Thus, the terminal 105 can demodulate and decode the outbound signal without additional processing. Interference cancellation is used at the hub station 103 to recover the weak inbound signals. In principle, the inbound signals are recovered by subtracting a “reconstructed” outbound signal from the composite received signal, according to the following:
x_{C}=x_{IN}+x_{OUT}
x_{C}=x_{IN}−x_{OUT}
However, as described below, the non-linear characteristics make this straightforward approach less effective.

One approach to obtaining the inbound signal from the composite signal, in which the composite signal is generated by a linear amplifier, is described in commonly assigned U.S. Pat. No. 5,625,640 to Palmer et al., which is incorporated herein by reference in its entirety.

In the example of FIG. 1, it is assumed that the satellite transponders are non-linear repeaters. As a result, the non-linearity of the communications channel presents additional challenges over the system described in U.S. Pat. No. 5,625,640. The response of satellite TWTA drifts due to aging or environmental change. Satellite hubs that adopt interference or non-linearity cancellation algorithms need to track the real-time response of TWTAs in satellites.

According to an exemplary embodiment, the system 100 can be deployed to provide Internet connectivity to users served by the terminal 105. The hub 103, for example, can possess connectivity to the Internet (not shown) via fiber-optics link. By way of example, a user seeking to access a web server from the Internet, the terminal 105 first sends out a web request to the hub station 103 via a satellite channel. The hub station 103 fetches the information from the Internet through its high-speed fiber connection, then distributes the information to the user's terminal 105. Under this scenario (as mentioned previously), the satellite channel from the terminal 105 to the hub station 103 is termed an “inroute,” while the satellite channel from the hub station 103 to the terminal 105 may be denoted as an “outroute.”

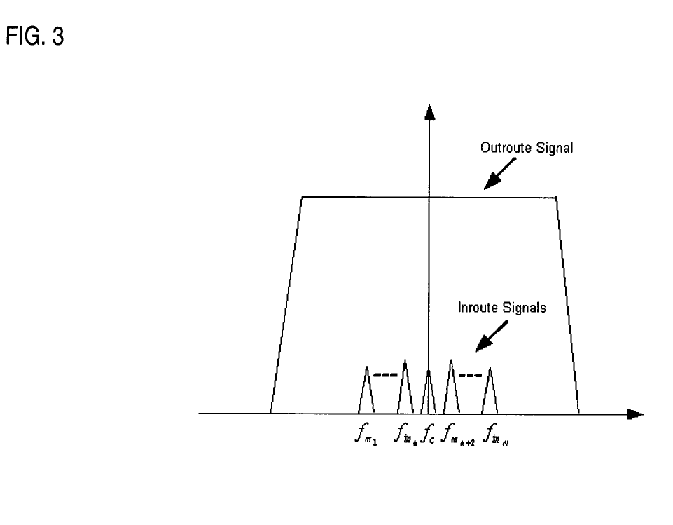

The system 100 can effectively be viewed as a multiple-input-multiple-output (MIMO) modem. That is, the multi-user system 100 passes one outroute and a number of inroutes through the same transponder, i.e., the outroute and inroutes use the same frequency band. FIG. 3, below, shows the spectrum of both the inroutes and outroute. Essentially, the hub station 103 is equipped with the MIMO modem, which demodulates the signals from the inroutes based on multi-user detection principles.

The remote terminals (of which only terminal 105 is shown) can demodulate the outroute signal without difficulty, as the outroute signals are much more powerful than the inroute signals (e.g., the power of an outroute may be up to 33 dB larger than that of an inroute). Assuming, for example, that the total number of inroutes in the system 100 is up to 50, the power of inroute interference can be at least 16 dB (33−10 log 50=16) below that of the outroute, which is very small compared with the additive white Gaussian noise (AWGN) at the receiver front end of remote terminals.

However, with respect to the hub station 103, discerning the relatively weak inroutes poses a challenge. This challenge is heightened by the fact that the satellite channel from the satellite 101 to the hub station 103 is non-linear due to the TWTAs in satellites 101. The intermodulation interference caused by the non-linearity of TWTAs can decay the inroute signals drastically.

Response of a TWTA can be characterized by its AM/AM and AM/PM conversions. That is, it is a memoryless device, which distorts the magnitude and phase of its input signal, and both the distortions are non-linear functions of its input power. The real-time response of TWTA in the satellite 101 changes continuously due to component aging, environmental change, etc.

The system 100 can be mathematically represented as follows. Assuming N (e.g., N=50) inroutes in the system 100, the transmitted signal xₖ(t) from inroute k is according to the following Equation (1):

$${x}_{k} ( t ) = {\sum }_{i} {A}_{k} {a}_{i , k} g ( t - iT - {τ}_{k} ) {ⅇ}^{j ( 2 π {f}_{k} t + {ϕ}_{k} )} ,$$

where a_{i, k} are modulated data symbols drawn from the complex plain (e.g., Quadrature Phase Shift Keying (QPSK) signals) with E[|a_{i, k}|²]=1, Aₖ is the signal magnitude, g(t) is the transmitter pulse shaping function (squared root raised cosine function with rolloff factor α=0.45), fₖ is the carrier frequency. The symbol rate (1/T) of each inroute, for example, can be 128 Kbps, and the channel spacing between two inroutes is 256 KHz. Variables τₖ and φₖ emulate the symbol timing offset and carrier phase offset respectively.

The outroute signal y(t) is given by the following Equation (2):

$$y ( t ) = {\sum }_{i} {A}_{or} {c}_{i} h ( t - iT - {τ}_{or} ) {ⅇ}^{j {ϕ}_{or}} ,$$

where cᵢ are modulated data symbols, Aₒᵣ is the signal magnitude, h(t) is the transmitter shaping function (with rolloff factor α=0.2), where the baseband complex envelope is used and the carrier frequency is set equal to zero. The input signal of the TWTA in one satellite transponder is the combination of the inroute signals, outroute signal and uplink noise as in Equation (3):

$${s}_{u} ( t ) = y ( t ) + {\sum }_{k = 1}^{N} {x}_{k} ( t ) + {n}_{u} ( t ) ,$$

, where nᵤ(t) is the uplink AWGN noise with two sided power spectrum density N_{0,u}. The power of outroute is much higher that that of an inroute, for instance, 20 log(Aₒᵣ/Aₖ)=33 dB. A typical uplink SNR (i.e., Aₒᵣ,/N_{0,u}) is around 18.6 dB in the satellite system. The signal sᵤ(t) in the equation above is converted to the downlink frequency band, then amplified by the TWTA before it is retransmitted to the earth.

The non-linear distortions of a TWTA include its AM/AM and AM/PM conversions. Let A(r) and φ(r) be the AM/AM and AM/PM conversions respectively, where r is the magnitude of its input signal. The saturation power of a TWTA is defined as the maximum input power after which the TWTA output power stops increasing (and may start decreasing). In the following presentation, all the powers are normalized to the saturation power. The non-linear distortions are expressed by Equations (4) and (5):

$$A ( r ) = \frac{{α}_{a} r}{1 + {β}_{a} {r}^{2}}$$

$$Φ ( r ) = \frac{{α}_{p} {r}^{2}}{1 + {β}_{p} {r}^{2}} ,$$

where αₐ, βₐ, αₚ, βₚ, are the four positive parameters uniquely specifying a TWTA.

With the system 100, the inbound signal from the terminal 105 can utilize any modulation, coding format (with or without spectrum spreading), whereas conventional approaches generally rely on the spread-spectrum nature of inbound signals to suppress any non-linear effect. Thus, the interference cancellation mechanism of the system 100 can be implemented without spectrum spreading. Additionally, traditional systems fail to adequately address the effect of the non-linearity in the repeater, providing no solution to counteract the degradation caused by such non-linearity.

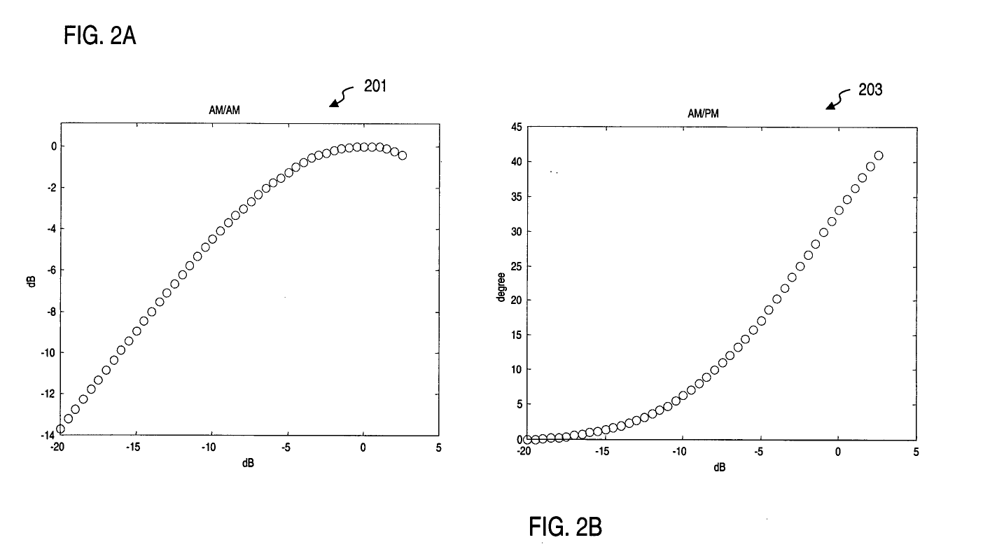

According to one embodiment of the present invention, power amplifiers (e.g., TWTAs) utilized in the transponders of the satellite 101 exhibit non-linear characteristics described below in FIGS. 2A and 2B.

FIGS. 2A and 2B are graphs showing exemplary non-linear characteristics of an amplifier used in the system of FIG. 1. To achieve high power efficiency, the power amplifier in the repeater 101 is driven near saturation by the outbound signal. Unfortunately, operating near saturation yields non-linear behavior, in terms of amplitude and phase, as shown in graphs 201, 203, respectively. The non-linearity can be described by the AM/AM and AM/PM conversion functions of the power amplifier. The graphs 201, 203 show characteristics of a practical Traveling Wave Tube amplifier AM/AM and AM/PM conversion functions often used by satellite communications. It is clear that these functions are not linear when the amplifier is operated close to saturation point of the AM/AM conversion function. With respect to the graph 201, the amplitude behaves non-linearly above −5 dB; as regards the phase, from below −10 dB, the amplifier operates non-linearly. These non-linear characteristics of the power amplifier are a major impairment for accurate cancellation.

Non-linearity can cause intermodulation distortion when multiple signals are sent through the same power amplifier. Additionally, weaker signals are suppressed when they are amplified along with a much stronger signal. Depending on the number of inbound signals overlaid with the outbound signal, and how close to saturation the amplifiers are operated at, the residual interference can be at about the same level of thermal noise floor due to imperfect cancellation. As discussed previously, conventionally, spread spectrum inbound signals were deployed to address this cancellation challenge; however, these impairments were suppressed at the expense of overall capacity. That is, such impairments would be more severe if the inbound signals are TDMA-based instead of CDMA-based.

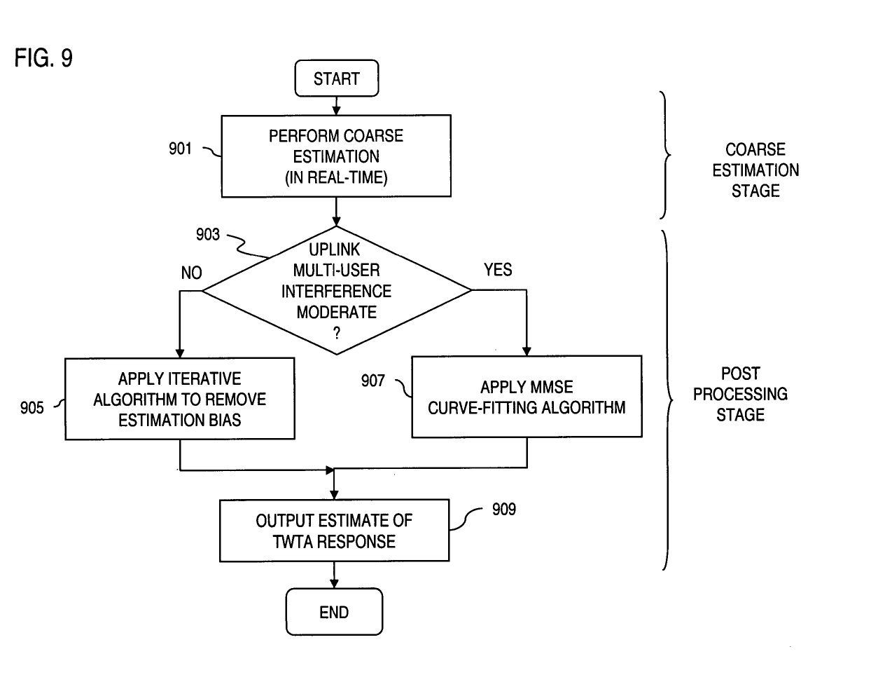

In the system 100, according to an embodiment of the present invention, the outbound signals transmitted from the hub station 103 are used as the training signals, the algorithm of the present invention does not use extra training signals. In order to combat both the uplink and downlink interference, the estimation algorithm, according to one embodiment of the present invention, includes two stages: a coarse estimation stage pre-estimates the AM/AM and AM/PM responses of the TWTA based on the temporal downlink signal samples that carries all the information related to the TWTA, and a post-processing stage uses an iterative curve-fitting algorithm to remove both the uplink and downlink interference. This approach is detailed below in FIGS. 9-12.

FIG. 3 is a diagram of the spectrum of an outbound signal overlaid onto inbound signals, according to an embodiment of the present invention. As mentioned above, the system 100 utilizes an overlay approach, whereby the aggregated inbound signals partially occupy the spectrum of the outbound signal. The spectral configuration of the inbound signals can be manipulated to assist with compensating for the non-linear effects of the satellite channel of the system 100; this approach is detailed in commonly assigned co-pending application to Feng-wen Sun, entitled “Compensating for Non-linearity in an Overlaid Communication System” (Attorney Docket No. PD-202100), filed Feb. 21, 2003; which is incorporated by reference in its entirety.

As shown in FIG. 3, the spectral configuration of inbound signals can be centered around the center frequency of the outbound signal (i.e., low-pass configuration). Other configurations include a uniformly spaced configuration and a bandpass configuration. The uniform spectral configuration provides equally spaced inbound signals over the outbound signal, while the bandpass configuration has the inbound signals occupying the high frequency band of the outbound spectrum. The system 100 can more completely compensate for the non-linearity by accounting for the above inbound spectral configurations.

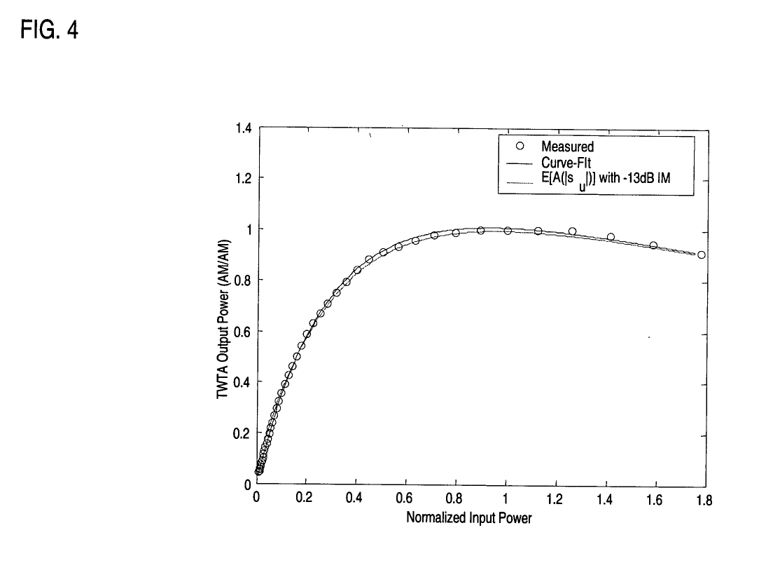

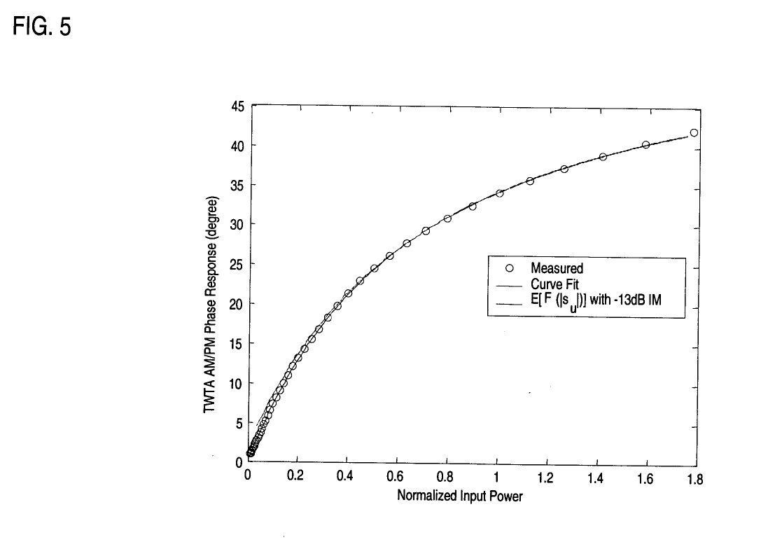

FIGS. 4 and 5 are graphs, respectively, of AM/AM and AM/PM responses of an exemplary Travelling wave-Tube Amplifier (TWTA), according to an embodiment of the present invention. For purposes of explanation, measured AM/AM and AM/PM responses are shown of one TWTA in the satellite 101 and their corresponding curve-fitting results (the solid lines) using Equations (4) and (5) with αₐ=2.0763, βₐ=1.0692, αₚ=83.723 (φ(r) in degrees), and βₚ=1.4404. As seen in FIG. 4, the TWTA response is nearly linear when the input power is small. The output power starts decreasing when the input power exceeds the saturation power (i.e., one in FIG. 4). As shown, the model fits the field data well. The downlink signal s_{d}(t) at the receiver front end in the hub is as follows (Equation 6):
s_{d}(t)=A(|sᵤ(t)|)e^{j[arg(s}^{ᵤ}^{(t))+Φ(|s}^{ᵤ}^{(t)|)]}+n_{d}(t),
where n_{d}(t) is the AWGN downlink noise with two-sided power spectrum density N_{0,d,} and E[A(|sᵤ(t)|)²]/N_{0,u} ranges from 20 dB to 35 dB depending on weather conditions.

The present invention, according to one embodiment, estimates the AM/AM conversion A(r) and the AM/PM conversion Φ(r) from the downlink signal s_{d}(t).

Various notations are used herein, some of which are enumerated below in Table 1, below.

TABLE 1

| Signal | Description |
|---|---|
| y(t) | outroute signal with average power Aₒᵣ² |
| xₖ(t) | inroute k signal with average power up to 33 dB |
| | below y(t) |
| nᵤ(t) | uplink AWGN noise with average power 15.6 dB |
| | below y(t) |
| sᵤ(t) | TWTA input, sᵤ(t) = y(t)+ Σₖ xₖ(t) + nᵤ(t) |
| A(\|sᵤ(t)\|) | TWTA AM/AM conversion of sᵤ(t) |
| Φ(\|sᵤ(t)\|) | TWTA AM/PM conversion of sᵤ(t) |
| n_{d}(t) | downlink AWGN noise, downlink SNR ranges from |
| | 20 dB to 35 dB |
| s_{d}(t) | input signal of the hub, TWTA output plus n_{d}(t) |

Conventional TWTA models assume a bandpass non-linearity and are based one tone static measurements. Such a model is valid for most communication problems where the input signal is narrow-band compared to the carrier frequency. The process of using CW signals as a training signal and then sweeping the TWTA under lab conditions is mainly conducted in the frequency domain due to the limitations of test equipment.

Temporal measurements of TWTA response can provide a better alternative because they preserve all the amplitude and phase information. However, they require very high speed digital signal processing (DSP). With the advance of VLSI (Very Large Scale Integration) and DSP techniques, temporal measurements are feasible. Conventional temporal measurements also assume lab environments and use training signals (e.g., CW, two tones, or known modulated data). These methods are difficult to apply to the TWTAs operating in communication satellites because they are not robust to the uplink noise and interference, and thus, require extra overhead—in form of training signals.

By contrast, the approach, according to an embodiment of the present invention, employs the wide-band high-power outroute signal (FIG. 3) as the training signals and treats other interference as noise. The estimates of the AM/AM and AM/PM conversions could be based on the magnitudes and phases of the means of temporal samples whose corresponding training signals have the same power levels, similar to a histogram-type averaging with respect to the input power. However, the uplink multi-user interference imposes significant bias on the TWTA estimation.

The TWTA's AM/AM and AM/PM responses are not arbitrary non-linear functions, they follow Equations (4) and (5). It is recognized that the model in Equations (4) and (5) reveals the impact of multi-user interference on the estimation analytically, leading to a curve-fitting algorithm that estimates the uplink interference level effectively and compensates it in an iterative way.

The hub station 103 tries to estimate the AM/AM and AM/PM conversions from the temporal samples of downlink signal s_{d}(t). The outroute signal y(t) is used as the training signal, which can be stored in the hub transmitter or demodulated and remodulated from s_{d}(t).

The outroute signal y(t) dominates the TWTA input sᵤ(t). Iᵤ(t) is defined as the sum of the inroute signals and uplink noise as follows in Equations (7) and (8):

$${I}_{u} ( t ) = {\sum }_{k = 1}^{N} {x}_{k} ( t ) + {n}_{u} ( t ) . \\ If {s}_{u} ( t ) \approx y ( t ) , then$$

$${s}_{d} ( t ) \approx A ( \vert y ( t ) \vert ) {ⅇ}^{j [ arg ( y ( t ) ) + Φ ( y ( t ) ) ]} + {n}_{d} ( t ) .$$

Multiplying s_{d}(t) by e^{-jarg(y(t))} can remove the phase modulation in s_{d}(t). Based on s_{d}(t) e^{-jarg(y(t))} an attempt to estimate A(|(t)|) and Φ(|(t)|) can be made.

Signal Iᵤ(t) is a nuisance parameter in the estimation, and has the following statistical properties. Since the data symbols a_{i,k} of inroute k are zero mean and i.i.d., the mean of Iᵤ(t) is the following:
E[Iᵤ(t)]=0,

Furthermore, Re(Iᵤ(t)) and Im(Iᵤ(t)) are zero-mean and independent with each other. The variance of Iᵤ(t) is according to Equation (9):

$$\begin{matrix}E [ {\vert {I}_{u} ( t ) \vert}^{2} ] = {\sum }_{k = 1}^{N} E [ {\vert {a}_{i , k} \vert}^{2} ] {A}_{k}^{2} {\sum }_{l} {g ( t - lT - {τ}_{k} )}^{2} + E [ {\vert {n}_{u} ( t ) \vert}^{2} ] \\ = \frac{{\sum }_{k = 1}^{N} {A}_{k}^{2}}{T} {\sum }_{l} 𝒢 ( \frac{2 π l}{T} ) {ⅇ}^{j 2 π l ( t - {τ}_{k} ) / T} + \frac{{N}_{0 , u}}{2}\end{matrix}$$

where G(f)=G(f) \mathring{x}G(f), i.e. the Fourier transform of g(t)²; the second equality follows the Poisson Sum Formula.

The AM/AM and AM/PM distortions cause the intermodulation interference between y(t) and Iᵤ(t). The intermodulation interference contributes to the estimation bias. Because TWTA is a memoryless device, the variable, t, can be removed for simplicity in the following presentations. Rewriting the magnitude of TWTA output A(|sᵤ(t)|) as a function of |sᵤ(t)|² and using Taylor series expansion, the following approximation is obtained (Equation (10)):

$$E [ A ( \vert {s}_{u} \vert ) ] \approx A ( \vert y \vert ) + \frac{{α}_{a} - 6 {α}_{a} {β}_{a} {\vert y \vert}^{2} + {α}_{a} {β}_{a}^{2} {\vert y \vert}^{4}}{4 {( 1 + {β}_{a} {\vert y \vert}^{2} )}^{3} \vert y \vert} E [ {\vert {I}_{u} \vert}^{2} ] .$$

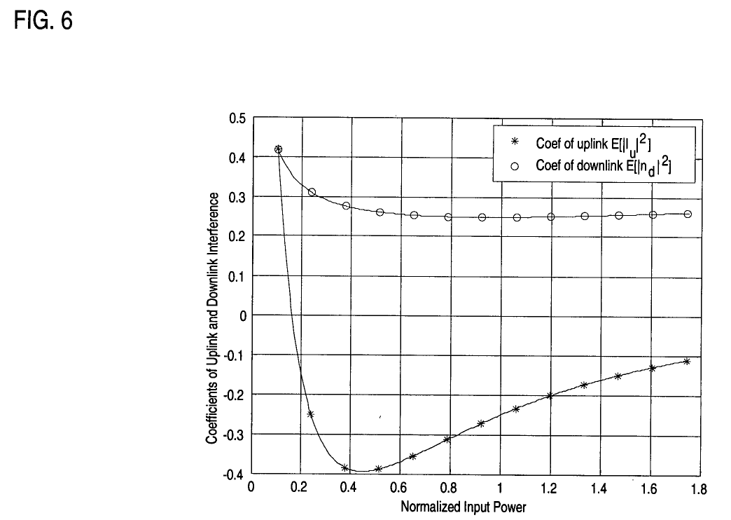

The dash line in FIG. 4 plots E[A(|sᵤ(t)|)] for the TWTA in satellite 101 with E[|Iᵤ(t)|²]=−13 dB (normalized to the saturation power). When the input power is small (e.g., less than 0.2 for the TWTA shown in FIG. 4), the uplink multi-user interference E[|Iᵤ(t)|²] tips A(|sᵤ(t)|) a large positive bias; when the input power increases, the bias becomes negative. The coefficient of E[|Iᵤ(t)|²] in Equation (10) was shown in FIG. 6 (the line with asters) for the same TWTA in satellite 101.

Similarly, the expectation of Φ(|sᵤ|) is approximated by Equation (11):

$$E [ Φ ( \vert {s}_{u} \vert ) ] \approx Φ ( \vert y \vert ) + \frac{{α}_{p} ( 1 - {β}_{p} {\vert y \vert}^{2} )}{{( 1 + {β}_{p} {\vert y \vert}^{2} )}^{3}} E [ {\vert {I}_{u} \vert}^{2} ] .$$

The dash line in FIG. 5 plots E[Φ(|sᵤ|)] for the same TWTA with E[|Iᵤ|²]=−13 dB. The intermodulation interference leads to a large estimation bias of Φ(|y|) when the input power is small; the bias diminishes when the input power increases.

In addition to the intermodulation interference introduced by Iᵤ(t), the TWTA estimation algorithm has to handle the downlink noise n_{d}(t). Two methods are provided to mitigate the impact of n_{d}. The first method obtains the coarse estimates of the TWTA response by computing E[|s_{d}|] and E[arg(s_{d})] through averaging or low-pass filtering the raw estimates of A(|y|) (≈|s_{d}|) and Φ(|y|) (≈arg(s_{d})−arg(y)).

The second method obtains the coarse estimates of the TWTA response by a “histogram-type” averaging, as mentioned earlier; that is, computing |E[s_{d}e^{-jarg(y)}]| and arg[E[s_{d}e^{-jarg(y)}]]. Although this second method can remove the downlink noise n_{d} completely, this technique ignores one important fact that the residue terms in both A(|sᵤ|) and Φ(|sᵤ|) are caused by the same uplink interference. It can be shown that the residue terms in A(|sᵤ|) and Φ(|sᵤ|) enhance the bias in the estimate of A(|y|) through the averaging operation.

For a small n_{d}, the following approximation results (Equation (12)):

$$\begin{matrix}E [ \vert {s}_{d} \vert ] \approx E [ A ( \vert {s}_{u} \vert ) ] + \frac{E [ {\vert {n}_{d} \vert}^{2} ]}{4 A ( \vert y \vert )} \\ = A ( \vert y \vert ) + \frac{{α}_{a} - 6 {α}_{a} {β}_{a} {\vert y \vert}^{2} + {α}_{a} {β}_{a}^{2} {\vert y \vert}^{4}}{4 {( 1 + {β}_{a} {\vert y \vert}^{2} )}^{3} \vert y \vert} E [ {\vert {I}_{u} \vert}^{2} ] + \frac{E [ {\vert {n}_{d} \vert}^{2} ]}{4 A ( \vert y \vert )} .\end{matrix}$$

The impact of the downlink noise on the estimate of A(|y|) is given by the third term in Equation (12). The coefficient (i.e., ¼A(|y|)) of E[|n_{d}|²] is shown in FIG. 6 (the line with circles), which is comparable with the coefficient of E[|Iᵤ²].

Within E[|s_{d}|], it is observed that the bias caused by n_{d} (the third term in Equation (12)) is positive, and the bias caused by Iᵤ(t) (the second term in Equation (12)) is negative when the input power |y|² is reasonably large (e.g., |y|²>0.2); these terms actually negate each other's impact even though they enhance each other when |y|² is small.

The phase of s_{d} is expressed as follows in Equation (13):

$$E [ arg ( {s}_{d} ) ] \approx E [ Φ ( {s}_{u} ) ] - \frac{1}{2} E [ tan ( Φ ( {s}_{u} ) ) ] E [ {\vert {n}_{d} \vert}^{2} ] .$$

The power of n_{d} is very low, thus its negative impact on the estimation of A(|y|) and Φ(|y|) is small.

The first method can be employed to mitigate the downlink noise when the downlink noise is small and the uplink noise and interference are severe. However, when the uplink noise and interference are negligible and the downlink noise is severe, the later “histogram-type” averaging technique can be used.

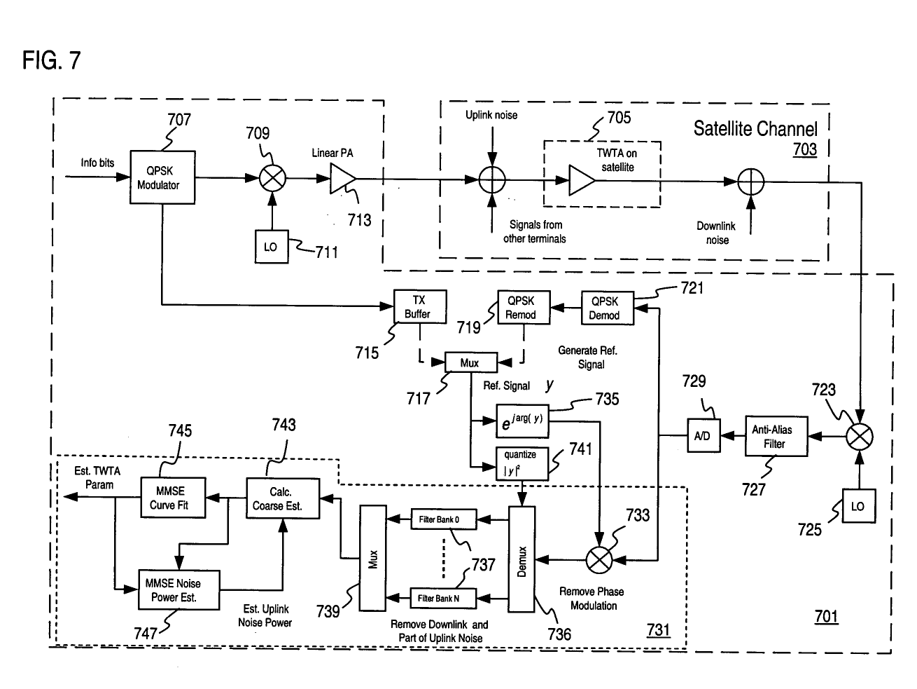

FIG. 7 is a diagram of a transceiver circuitry for providing TWTA response estimation utilized in the system of FIG. 1. The transceiver circuitry 701, which in an exemplary embodiment, is resident in the hub station 103, communicates over a satellite channel 703. With respect to the TWTA 705 of the satellite 101, this channel 703 can be modeled such that the contribution to the overlaid signal as output from the TWTA 705 stems from the outroute signal from the hub station 103, the uplink noise, and the inroute signals from the terminals. The overlaid signal output from the TWTA 705 is further subject to the downlink noise.

The outroute signal is generated based on information bits that are input into a modulator 707, which utilizes, for example, a QPSK modulation scheme. The QPSK signal is mixed (via a mixer 709) with a carrier signal provided by a local oscillator (LO) 711 and forwarded to a linear power amplifier (PA) 713. This QPSK signal can also be stored in a transmit (TX) buffer 715. It is noted that the outroute signal can be generated by storing it in the transmitter, or by demodulating and remodulating the received signal in the receiver.

The stored signal within the TX buffer 715 is used to output a reference signal of the outroute signal, y(t). The outroute signal is regenerated via a multiplexer 717, which receives input from a QPSK remodulator 719, which effectively modulates the received overlaid signal from a QPSK demodulator 721. The multiplexer 717 selects either the signal stored in the transmitter or the regenerated signal in the receiver as the reference signal.

As seen on the right side of FIG. 7, the received overlaid signal is frequency shifted using a mixer 723 based on the frequency provided by a local oscillator 725. The downshifted signal from the mixer 723 is filtered used an anti-alias filter 727. The filtered signal is fed into an Analog-to-Digital (A/D) converter 729. The AID converter 729 outputs to the QPSK demodulator 721 as well as to a TWTA Response Estimator 731.

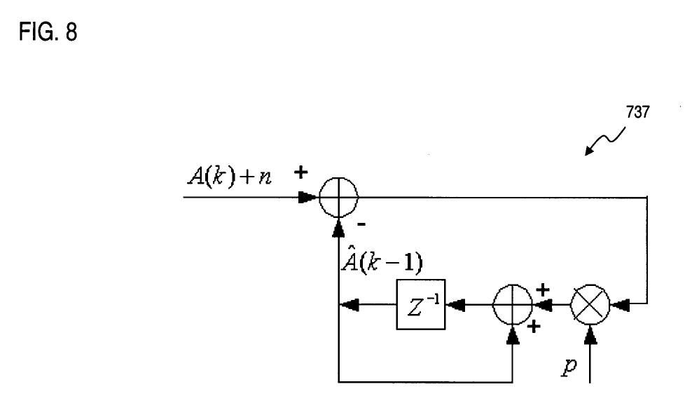

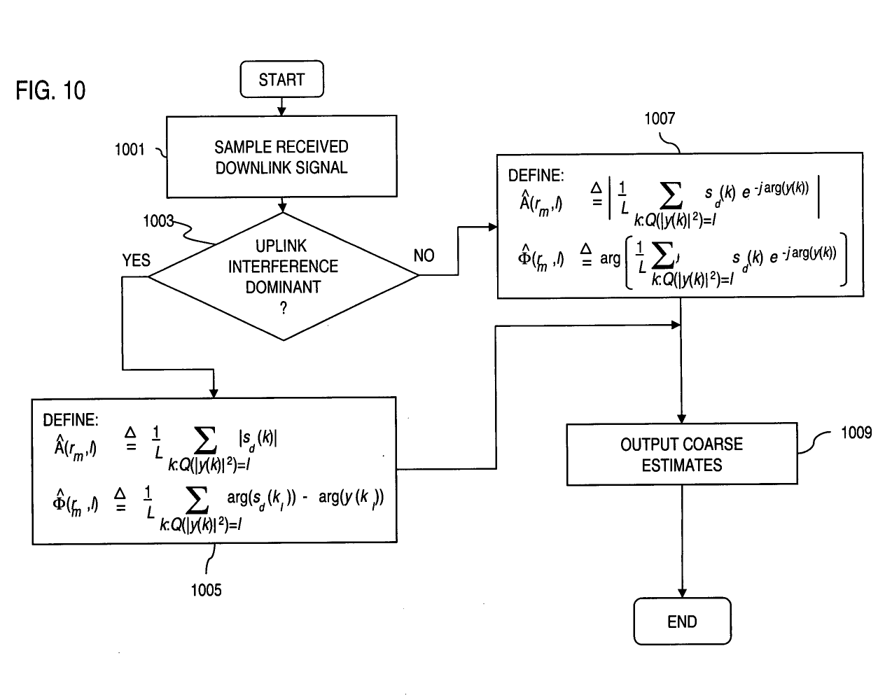

The operation of the TWTA Response Estimator 731 can be divided into two stages: coarse estimation and post processing. This operation is described more fully below with respect to FIGS. 10-12. The signal output from the A/D converter 729 enters a mixer 733 of the TWTA Response Estimator 731 for removal of the phase modulation. The mixer 733 also receives input from a multiplier 735 that outputs e^{jarg(y)}, based on the outroute reference signal. The TWTA Response Estimator 731 includes a demultiplexer (DEMUX) 736, N number of filters 737, and a multiplexer 739 for removing the downlink and some of the uplink noise according to the quantization of the input power |y(k)|², which is supplied by a quantizer 741 that is external to the TWTA Response Estimator 731. FIG. 8 is a diagram of an exemplary filter 737 used in the TWTA Response Estimator 731. The filter 737 is a first-order low-pass filter, as represented by Equation (22), below.

The multiplexer (MUX) 739 outputs to a Coarse Estimation module 743 for calculating the coarse estimates, which are supplied to a pseudo minimal-mean-squared-error (MMSE) Curve-fitting module 745 as well as a MMSE Noise Power Estimation module 747; this module 747 feeds back the estimated uplink noise power to the Coarse Estimation module 743. The MMSE Curve-fitting module 745 lastly outputs the estimated TWTA response. This estimate can be used to assist with cancellation of the non-linear effects of the satellite channel 703.

The operation of the TWTA Response Estimator 731 is more fully described in FIGS. 9-12.

FIG. 9 is a flowchart of the operation of the TWTA response estimation circuit of FIG. 7. As mentioned previously, the estimation process can be viewed in two stages: a Coarse Estimation stage, and a Post Processing stage. In step 901, the coarse estimates are output; according to one embodiment of the present invention, these estimates are generated in real-time. Next, in step 903, it is determined whether the uplink multi-user interference is moderate, as different techniques are based on the severity of the interference. If the interference is severe, the estimation bias is removed, as in step 905, through an iterative algorithm. However, if the interference is moderate, the MMSE curve-fitting algorithm is executed, per step 907.

It is instructive to describe the pseudo minimal-mean-squared-error (MMSE) curve-fitting algorithm (as performed by the MMSE curve-fitting module 745) that estimates the four parameters in Equations (4) and (5) based on the observations of TWTA output. This scheme is more fully described in “Frequency-independent and Frequency-dependent Non-linear Models of TWT Amplifiers,” by A. A. M. Saleh (IEEE Transaction on Communications, Vol. COM-29, No. 11, pp. 1715-1720), November, 1981); which is incorporated herein by reference in its entirety. Equations (4) and (5) have the following general form (Equation (14)):

$$z ( r ) = \frac{α {r}^{n}}{{( 1 + β {r}^{2} )}^{v}} ,$$

where n and v are positive integers. Based on m measured pairs (zₗ, rₗ), l=1, 2, . . . , m, the true MMSE estimates of α and β should minimize the following mean-squared error:

$${\sum }_{l} {( {z}_{l} - \frac{α {r}_{l}^{n}}{{( 1 + β {r}_{l}^{2} )}^{v}} )}^{2} .$$

However, solving the equations obtained by setting the partial derivatives of α and β to zero is mathematically intractable. It is recognized that Saleh's “optimal” α and β actually minimize the following mean-squared-error:

$${\sum }_{l} {( {( \frac{{r}^{n}}{{z}_{l}} )}^{1 / v} - \frac{1 + β {r}_{l}^{2}}{{α}^{1 / v}} )}^{2} .$$

The following is first defined as follows (Equation (15)):

$${w}_{l} = {( \frac{{r}_{l}^{n}}{{z}_{l}} )}^{1 / v} , l = 1 , 2 , ⋯ , m$$

then Equations (16) and (17) result:

$$α = {[ \frac{{( \sum {r}_{l}^{2} )}^{2} - m \sum {r}_{l}^{4}}{( \sum {r}_{l}^{2} ) ( \sum {w}_{l} {r}_{l}^{2} ) - ( \sum {r}_{l}^{4} ) ( \sum {w}_{l} )} ]}^{v} , \\ β = \frac{( \sum {r}_{l}^{2} ) ( \sum {w}_{l} ) - m \sum {w}_{l} {r}_{l}^{2}}{( \sum {r}_{l}^{2} ) ( \sum {w}_{l} {r}_{l}^{2} ) - ( \sum {r}_{l}^{4} ) ( \sum {w}_{l} )} .$$

It has been shown, through various studies, that the operation rⁿₗ/zₗ (e.g., |y(t)|/|s_{d}(t)|) actually enhances the noise when zₗ is small and the noise is not negligible. Estimating A(|y(t)|) directly based on Saleh's method and raw y(t) and |s_{d}(t)| introduces significant bias, while the Φ(|y(t)|) estimation does not work at all. Saleh's MMSE estimation of α and β works well for smooth data sets with little noise. The approach, according to an embodiment of the present invention, provides an improvement over the Saleh's algorithm.

The uplink multi-user interference Iᵤ and the downlink noise n_{d} contribute to the bias in those coarse estimates. The previous analysis shows that E[|s_{d}|] is a good coarse estimate of A(|y|), and E[arg(s_{d})−arg(y)] is a good coarse estimate of Φ(|y|) when the uplink noise and interference are the dominant source of bias. On the other hand, when the downlink noise is the dominant source of bias, |E[s_{d}]| is a good coarse estimate of A(|y|), and arg[E(s_{d}e^{-jarg(y)})] is a good coarse estimate of A(|y|). When Iᵤ is moderate, a simple curve-fitting using Saleh's pseudo MMSE algorithm can be adopted to mitigate the bias based on the coarse estimates with large input power, because the coarse estimates with small input power are corrupted by both Iᵤ and n_{d}. When Iᵤ is very severe, an iterative estimation algorithm is developed based on the residue analysis as earlier discussed with respect to the intermodulation interference analysis.

Thereafter, the estimate of the TWTA response is output, as in step 909.

FIG. 10 is a flowchart of the coarse estimation stage of the process of FIG. 9. In this stage, the received downlink signal s_{d}(t) is sampled every Tₛ (e.g., Tₛ=T/2) seconds to obtain digital samples s_{d}(k), per step 1001. The prestored or demodulated y(k)□y(kTₛ) is used to remove the phase modulation of s_{d}(k).

The coarse estimation stage accounts for two different scenarios (as determined in step 1003): when the uplink interference Iᵤ is dominant; and when the uplink interference Iᵤ is negligible and the downlink noise n_{d} is dominant. In the first scenario, the following samples are defined, according to Equations (18) and (19):
Â(|y(k)| [symbol] |s_{d}(k)|,
\hat{Φ}(|y(k)|) [symbol] arg(s_{d}(k))−arg(y(k)).

The samples of Â(|y(k)|) and \hat{Φ}(|y(k)|) are then passed respectively to two arrays of averaging devices or filter banks according to the quantization of the input power |y(k)|² to remove the noise and get the coarse estimates. Specifically, the TWTA input power r² is linearly quantized into M_{q} (e.g., M_{q}=256) entries in order to reduce complexity. That is, assuming the maximum input power is Rₘ² the step size of quantization is the following:
D_{q}=Rₘ²/M_{q}.

The quantization operation (defined as Q(.)) and its corresponding midpoint

$${r}_{m , l}^{2}$$

of each step are given by:
Q(r²) [symbol] {l|lD_{q}≦r²<(l+1)D_{q}},
r_{m,l}²=D_{q}(l+½),
where l=0, 1, . . . , M_{q}−1. For example, Q(|y(k)|²)=l(l∈[0, . . . , M_{q}−1]), in which its sampling instant k be kₗ, Â(|y(k)|²) and \hat{Φ}(|y(k)|) are passed to the averaging devices or the low pass filters G(Z) indexed by l as shown in FIGS. 7 and 8. The coarse estimates Â(r_{m,l}) of the AM/AM conversion and \hat{Φ}(r_{m,l}) of the AM/PM conversion are defined, per step 1005, as either of the following Equations (20) and (21):

$$\hat{A} ( {r}_{m , l} ) {=}^{Δ} E [ \hat{A} ( \vert {y}_{{k}_{l}} \vert ) ] = \frac{1}{L} {\sum }_{k : Q ( {\vert y ( k ) \vert}^{2} ) = l} \vert {s}_{d} ( k ) \vert$$

$$\hat{Φ} ( {r}_{m , l} ) {=}^{Δ} E [ \hat{Φ} ( \vert {y}_{{k}_{l}} \vert ) ] = \frac{1}{L} {\sum }_{k : Q ( {\vert y ( k ) \vert}^{2} ) = l} arg ( {s}_{d} ( {k}_{l} ) ) - arg ( y ( {k}_{l} ) )$$

where an averaging device is used, or s_{d}(k)e^{-jarg(y(k))} being filtered by a first-order low-pass filter Gₗ(z) shown in FIG. 8 (Equation (22)):

$${G}_{l} ( z ) = \frac{{ρ}_{l}}{z - ( 1 - {ρ}_{l} )} .$$

The advantage of low-pass filter is that it outputs a new estimate given a new input after the loop converges. Instead, the averaging device has to accumulate a block of data before it generates output. Classical loop analysis applies to the loop coefficient pi selection.

With respect to the second scenario in which the uplink interference Iᵤ is negligible, the manner in which Â(r_{m,l}) and \hat{Φ}(r_{m,l}), respectively Equations (23) and (24), are generated are given by (step 1007):

$$\hat{A} ( {r}_{m , l} ) {=}^{Δ} \vert \frac{1}{L} {\sum }_{k : Q ( {\vert y ( k ) \vert}^{2} ) = l} {s}_{d} ( k ) {ⅇ}^{- j arg ( y ( k ) )} \vert$$

$$\hat{Φ} ( {r}_{m , l} ) {=}^{Δ} arg [ \frac{1}{L} {\sum }_{k : Q ( {\vert y ( k ) \vert}^{2} ) = l} {s}_{d} ( k ) {ⅇ}^{- j arg ( y ( k ) )} ]$$

where an averaging device is used, or s_{d}(k)e^{-jarg(y(k))} being filtered by a first-order low-pass filter G_{l(z)} as above.

In step 1009, the samples, Â(r_{m,l}) and \hat{Φ}(r_{m,l}) are the coarse estimates. Instead of averaging, low pass filter banks can be used in Equations (23) and (24). Thereafter, the coarse estimates are output, per step 1011, for post processing.

The post processing stage considers two scenarios, when the interference Iᵤ is: moderate, and severe. In the first case, according to the intermodulation interference analysis previously described, the estimation bias caused by Iᵤ and n_{d} in both Â(|y(k)|) and \hat{Φ}(|y(k)|) is large when the input power

$${r}_{m , l}^{2}$$

is small as shown in FIG. 4 and FIG. 5. When the input power increases, the bias of the AM/PM estimate diminishes; the bias is of the AM/PM is small due to the mutual cancellation between Iᵤ and n_{d}.

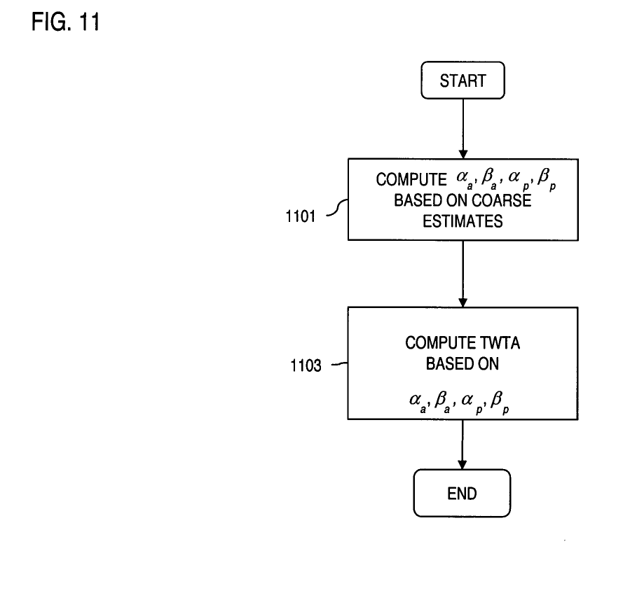

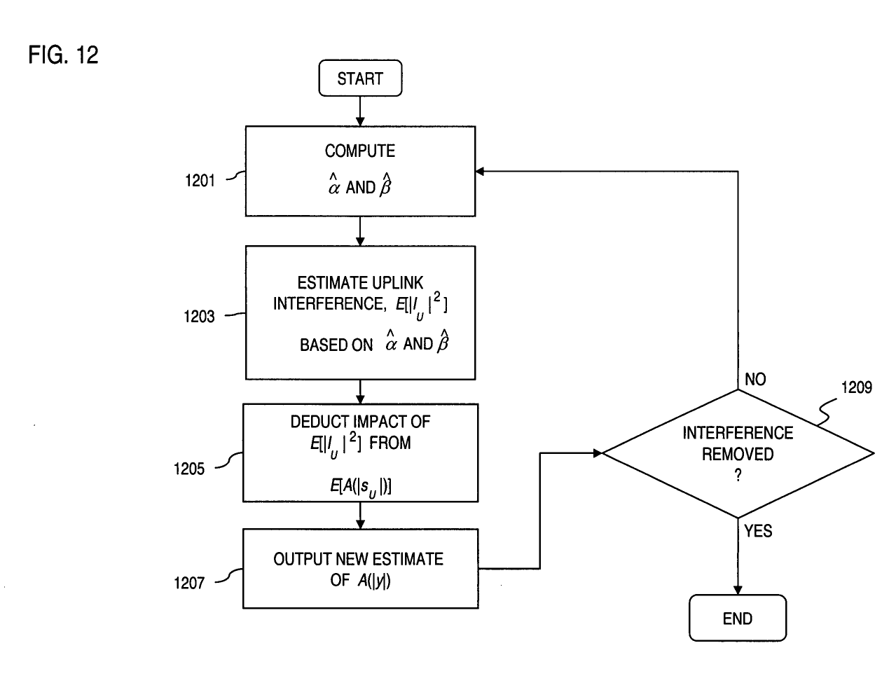

FIGS. 11 and 12 are flowcharts of the post processing stage of the process of FIG. 9. During this stage, instead of using the coarse estimates directly, the four parameters, αₐ, βₐ, αₚ, and βₚ, in Equations (4) and (5) can be computed, per step 1101, based on the coarse estimates with smaller estimation bias using, according to one embodiment of the present invention, Saleh's algorithm. In step 1103, the TWTA response is computed based on the four parameters and Equations (4) and (5).

In particular, for the AM/AM conversion, the wₗ in Equation (15) is given by Equation (25):

$${w}_{l} = \frac{{r}_{m , l}}{\hat{A} ( {r}_{m . l} )} , l = 0 , 1 , … , {M}_{q} - 1 ,$$

then αₐ and βₐ are computed, per step 1201, based Equations (16) and (17) and the samples with l=sₐ, . . . , M_{q}−1, where sₚ corresponds to the input power r_{m,s}_{ₐ}² after which the bias caused by Iᵤ in A(r) is negative. According to one embodiment of the present invention, samples with input power larger than a preset threshold (e.g., 0.2 can be used for most TWTAs) can readily be chosen.

Similarly, for the AM/PM conversion, the wₗ in Equation (15) is given by Equation (26):

$${w}_{l} = \frac{{r}_{m , l}^{2}}{\hat{Φ} ( {r}_{m . l} )} , l = 0 , 1 , … , {M}_{q} - 1 ,$$

then αₐ and βₐ are computed based Equations (16) and (17) and the samples with l=sₚ, . . . , M_{q}−1, where sₚ corresponds a preset threshold of the input power (e.g., 0.2). The final estimate of the AM/AM conversion, Â_{f}(r), is computed based on Equation (4) and the estimated αₐ and βₐ; the final estimate of the AM/PM conversion, \hat{Φ}_{f}(r), is computed based on Equation (5) and the estimated αₚ and βₚ.

To estimate the AM/AM conversion in the first scenario, E[A(|sᵤ|)] is used to perform the curve fitting, which includes A(|y|) and the bias caused by Iᵤ and n_{d}, instead of using the real A(|y|). When E[|Iᵤ|²] is large, such an approximation is less accurate; that is, when the interference Iᵤ is severe, as in the second scenario.

Ignoring the impact of n_{d}, E[A(|sᵤ|)] is expressed as in Equation (10). Assuming that the estimates of αₐ and βₐ using the curve fitting are close to the true values, the uplink interference power E[|Iᵤ|²] can be estimated, as in step 1203, from Equation (10) using the MMSE algorithm. The impact of this interference can then be deducted from E[A(|sᵤ|)] to obtain a new estimate of A(|y|), per steps 1205 and 1207. Based on the new estimate, the same procedure can be repeated until the bias caused by Iᵤ is removed “completely,” as determined according to step 1209. This approach encapsulates the iterative algorithm, which is further elaborated below.

For iteration i, the following are defined: the estimate of A(r_{m,l}) as Âᵢ(r_{m,l}), the estimates of αₐ and βₐ as _{a,i} and \hat{β}_{a,i} and the estimate of the uplink interference power E[|Iᵤ|²] as Êᵢ. First, initialization is performed, wherein Â₁(r_{m,l}) is set to Â(r_{m,i}) from the coarse estimation.

Next, the following process is executed iteratively, in which, for the purposes of explanation, the i^{th} iteration is described. \hat{α}_{a,i} and \hat{β}_{a,i} are computed using Âᵢ(r_{m,l}), and Saleh's MMSE curve-fitting algorithm, where l=sₚ, . . . , M_{q}−1. The temporary estimate of AM/AM conversion Âₜₘₚ(r_{m,l}) (l=sₚ, . . . , M_{q}−1) based on \hat{α}_{a,i} and \hat{β}_{a,i} and (4). Êᵢ is computed based on the following Equation (27):

$${\hat{E}}_{i} = \frac{{\sum }_{l} ( {\hat{A}}_{i} ( {r}_{m , l} ) - {\hat{A}}_{tmp} ( {r}_{m , l} ) ) C ( {\hat{α}}_{a , i} , {\hat{β}}_{a , i} , {r}_{m , l} )}{{\sum }_{l} {C ( {\hat{α}}_{a , i} , {\hat{β}}_{a , i} , {r}_{m , l} )}^{2}} ,$$

where the summation is over sₐ, . . . , M_{q}−1, and

$$C ( α , β , r ) {=}^{Δ} \frac{α - 6 αβ {r}^{2} + {αβ}^{2} {r}^{4}}{4 {( 1 + β {r}^{2} )}^{3} r} .$$

The new estimate Âᵢ₊₁(r_{m,l})(l=sₐ, . . . , M_{q}−1) is determined as follows (Equation (28)):
Âᵢ₊₁(r_{m,l})=Âᵢ(r_{m,l})−C(\hat{α}_{a,i}, \hat{β}_{a,i}, r_{m,l})Êᵢ
The calculation of Êᵢ in Equation (27) is based on minimizing the following criterion:

$${\sum }_{l}^{} {( {\hat{A}}_{i} ( {r}_{m , l} ) - {\hat{A}}_{tmp} ( {r}_{m , l} ) - C ( {\hat{α}}_{a , i} , {\hat{β}}_{a , i} , {r}_{m , l} ) {\hat{E}}_{i} )}^{2}$$

The iteration ends when Êᵢ is smaller than a preset threshold Pₜ. The final estimate Â_{f}(r_{m,l}) is based on the estimated αₐ and βₐ of the last iteration and Equation (4). The estimated noise power Êᵢ decreases fast with each iteration. Simulation reveals between 10 to 20 iterations are sufficient for the algorithm to converge, as described later. The same iterative algorithm can be applied to the first scenario, the resultant final estimate Â_{f}(r_{m,l}) are almost undiscriminating from the true response, i.e., the bias is totally removed. For the estimate of AM/PM conversion, similar iterative algorithm can be derived based on Equation (11). However, the algorithm in the first scenario performs well for E[|Iᵤ|,²] as large as, for example, −9 dB.

As evident from the above processes, the TWTA Response Estimator 731, according to one embodiment of the present invention, is robust to both the uplink and downlink noise and interference. This TWTA Response Estimator 731 can be deployed in various hub stations of multiuser satellite communication systems or as a standalone module. This estimator advantageously does not require training signals that consume transmission bandwidth or interferes with the normal operation of the hub stations.

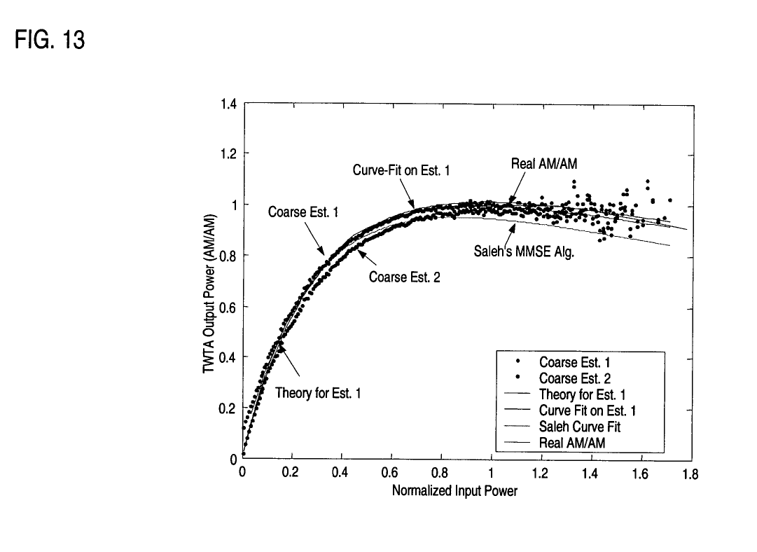

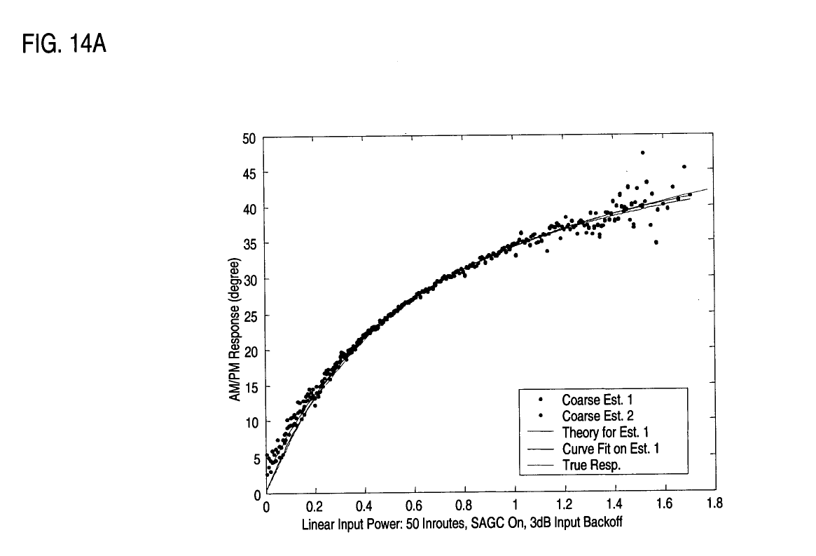

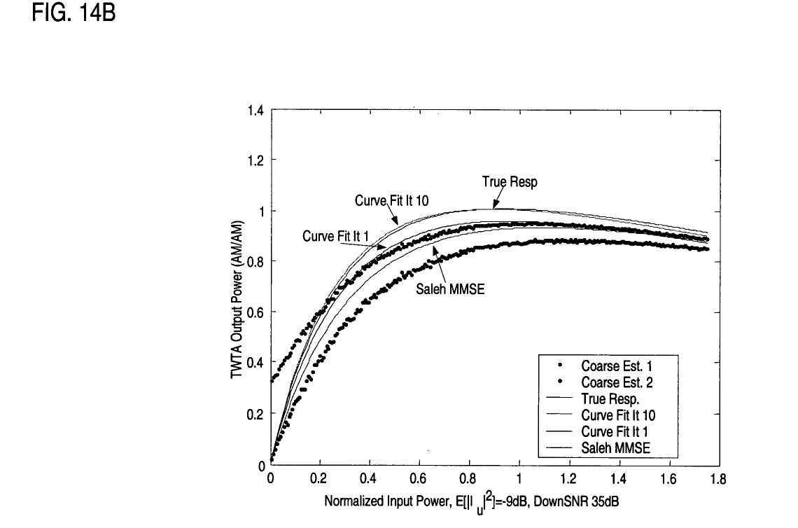

FIGS. 13, 14A, and 14B are graphs of simulation results of the estimated response of the TWTA Response Estimator. Before describing the simulation details, the following TWTA SNR criterion is provided to quantify the estimation performance. Using the uplink signal sᵤ(t) in Equation (3) as the input signal to TWTA, the ideal output of TWTA is give by:
A(|sᵤ(t)|)e^{j[arg(s}^{ᵤ}^{(t))+Φ(|s}^{ᵤ}^{(t)|)]},
the estimated TWTA output signal using the estimated αₐ, βₐ, αₚ, βₚ and the model in Equations (4) and (5):
Â_{f}(|sᵤ(t)|)e^{j[arg(s}^{ᵤ}^{(t))+Φ}^{_{f}}^{(|s}^{ᵤ}^{(t)|)]}.
The SNR_{TWTA} is defined as the ratio of the ideal TWTA output's mean power over the mean-squared error of the estimated TWTA output, i.e.,

$${SNR}_{TWTA} {=}^{Δ} \frac{E [ {A ( \vert {s}_{u} ( t ) \vert )}^{2} ]}{\begin{matrix}E [ \vert A ( \vert {s}_{u} ( t ) \vert ) {ⅇ}^{j [ arg ( {s}_{u} ( t ) ) + Φ ( \vert {s}_{u} ( t ) \vert ) ]} - \\ {{\hat{A}}_{f} ( \vert {s}_{u} ( t ) \vert ) {ⅇ}^{j [ arg ( {s}_{u} ( t ) ) + {\hat{Φ}}_{f} ( \vert {s}_{u} ( t ) \vert ) ]} \vert}^{2} ]\end{matrix}} .$$

FIG. 13 and FIG. 14A show the estimated response of the TWTA in satellite 101 using several algorithms. The simulation conditions are as follows: 50 inroutes (each inroute is 33 dB below the outroute), the uplink SNR is 18.6 dB, the TWTA input backoff is 3 dB, E[|Iᵤ|²]=−16.02 dB, the downlink SNR is 20 dB, 234,000 samples of sᵤ(t) are used.

In FIG. 13, the estimated AM/AM conversion (denoted by “Saleh's MMSE Alg.”) using Saleh's pseudo MMSE algorithm has significant amount of bias when the input power is larger than 0.4. Its output power Â_{f}(r)² is much smaller than the ideal response. FIG. 13 also shows two groups of coarse estimates of Â_{f}(r_{m,l}), one is based on E[|s_{d}|] (denoted by “Coarse Est. I”), the other is based on |E[|s_{d}|]| (denoted by “Coarse Est. 2”). The dash line (denoted by “Theory for Est. I”) plots the theoretical value of E[|s_{d}|] using (12). The noisy data with large input power (large than 1) in those coarse estimates is because there are not enough samples appearing there (i.e., with very small probability) instead of estimation bias. As discussed previously, the residue terms in both A(|sᵤ|) and Φ(|sᵤ|) enhance the bias in Â(r_{m,l}) during the averaging operation. The estimation bias is “Coarse Est. I” is much smaller that in “Coarse Est. 2.” The analytical result in Equation (12) fits the simulation results well. The final estimate Â_{f}(r) from the Post Processing stage in the first scenario almost complete removes the bias linked to the small input power and is very close to the real response.

Similarly, FIG. 14A shows the coarse estimate of AM/PM conversion \hat{Φ}(r) for the TWTA in satellite 101, 50 inroutes, uplink SNR 18.6 dB, E[|Iᵤ|²]=−16.02 dB, downlink SNR 20 dB, TWTA input backoff 3 dB, 234K input samples. As shown, two groups of coarse estimates of \hat{Φ}(r_{m,l}), are provided: one is based on the E[arg(s_{d})−arg(y)] (denoted by “Coarse Est. I”); the other is based on arg(E[s_{d}e^{-j arg(y)}]) (denoted by “Coarse Est. 2”). The bias in “Coarse Est. I” is smaller than that in “Coarse Est. 2” when the input power is small. The final estimate \hat{Φ}(r) from the Post Processing stage removes the bias link to the small input power completely and is very close to the real response.

When the uplink multiuser interference is severe, the iterative algorithm derived in the second scenario can be applied. FIG. 14B shows the estimation results of AM/AM conversion when E[|Iᵤ|²]=−9 dB. Other test conditions are the downlink SNR is 35 dB, the TWTA input backoff is 3 dB. It shows that the coarse estimates (“Coarse Est. 1(2)”) have big bias. The final estimate Â_{f}(r) based on the post progressing algorithm in the first scenario, denoted by “Curve Fit It. I”) is not satisfactory. The curve denoted by “Curve Fit It. 10” shows the final estimation result based on 10 iterations using the iterative algorithm in the second scenario, which removes most bias.

In order to test the robustness of the estimation algorithm, extensive simulations were run with different uplink interference, downlink noise and TWTA input backoff, in which the post processing algorithm in Scenario 1 was employed.

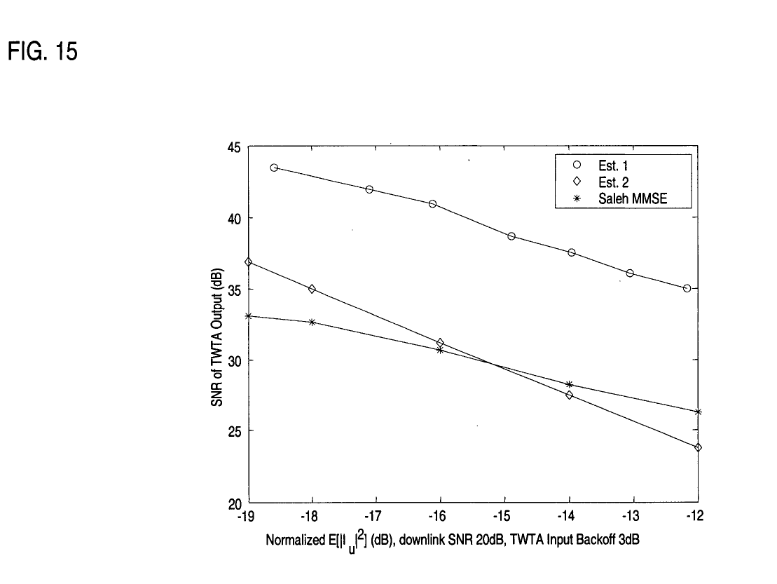

FIG. 15 shows the TWTA SNR defined in Equation (30) with different levels of uplink multiuser interference, in which the TWTA input backoff is 3 dB, and the downlink SNR is 20 dB. It is intuitive that larger uplink interference power E[|Iᵤ|²] (due to more or stronger inroutes) leads to larger estimation bias, thus degrading the estimation performance. For instance, when E[|Iᵤ|²]=−18.59 dB (2 inroutes, the uplink SNR=18.6 dB), SNR_{TWTA}=43.45 dB, when E[|I|²]=−17.10 dB (26 inroutes, the uplink SNR =18.6 dB), SNR_{TWTA} decreases to 41.96 dB.

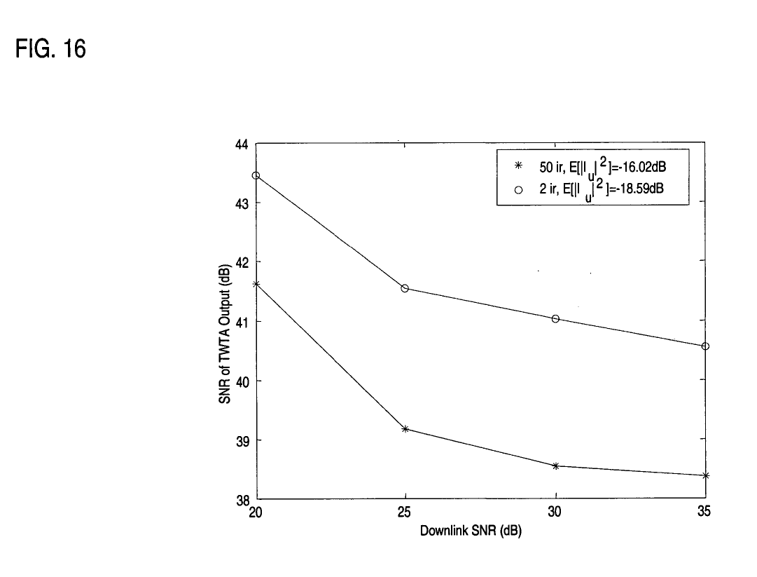

FIG. 16 shows the impact of the downlink noise on the estimation performance. As described previously, the downlink noise alleviate the impact of the uplink interference on the coarse estimate of Â(r_{m,l}). When the downlink noise is reasonably large, it is “good” noise since the estimation algorithm performs even better. For instance, when E[|Iᵤ²]=−16.02 dB (50 inroutes, the uplink SNR=18.6 dB) and the TWTA input backoff is 3 dB, SNR_{TWTA}=41.61 dB given the downlink SNR=20 dB, SNR_{TWTA} decreases to 38.37 dB when the downlink SNR increases to 35 dB. Smaller TWTA input backoff will introduce more non-linear distortion at the mean time the average TWTA output power increases.

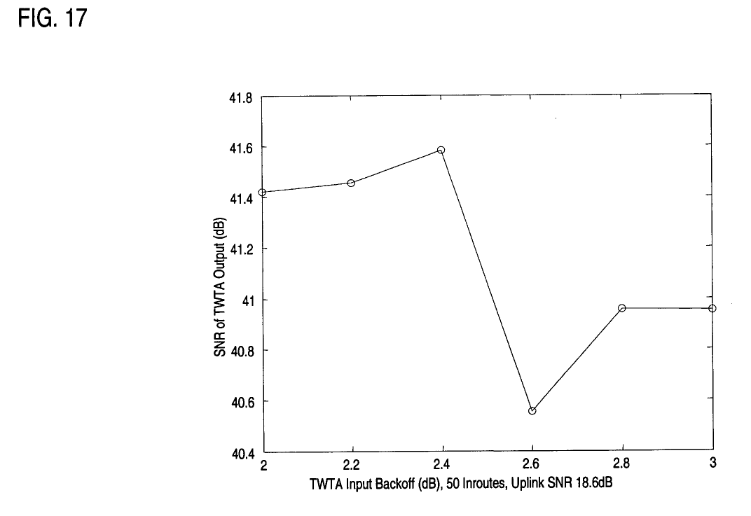

FIG. 17 shows the impact of the TWTA input backoff number on the estimation performance, where the uplink interference power E[|Iᵤ²] is −16.1 dB when the TWTA input backoff is 3 dB. Simulations show that the estimation approach of the TWTA Response Estimator 731 is quite immune to severe non-linearity. As noted, the TWTA response estimates are needed to effectively compensate for the non-linearity of the satellite channel 703.

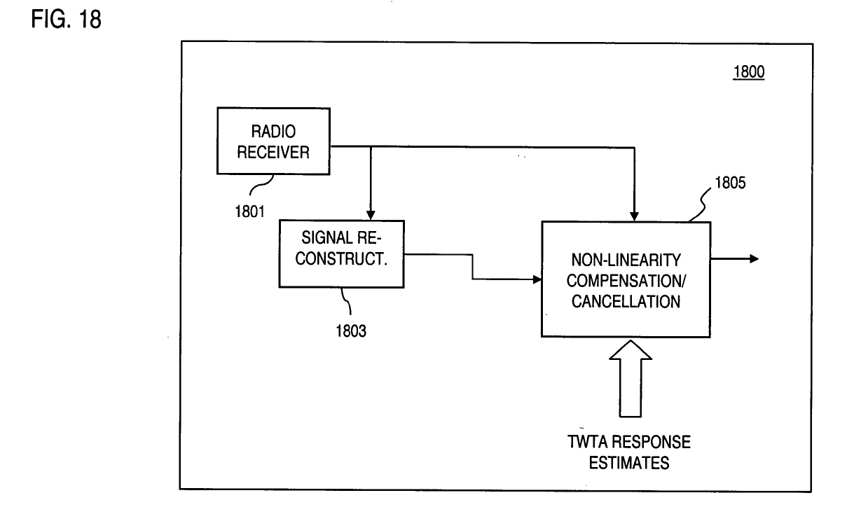

FIG. 18 is a diagram of a non-linearity compensation and cancellation circuitry that employs the TWTA response estimates output from the TWTA response estimation circuit of FIG. 7, according to an embodiment of the present invention. Receiver circuitry 1800, in an exemplary embodiment, can be deployed in the hub station 103 (FIG. 1) and extracts an inbound signal or multiple inbound signals from a composite signal received from the relay station 101. Conceptually, the received signal is sent through a “model” that emulates the repeater non-linearity and, optionally, a group delay of the noise-limiting filter.

The receiver circuitry 1800 includes a radio receiver 1801 for receiving the composite signal. To cancel the outbound signal from the composite received signal, the receiver 1801 at the hub station 103 needs to know what is transmitted from the hub station 103 as a reference. Because the outbound signal is significantly stronger than the inbound signals, the receiver 1801 can demodulate the composite (or overlaid) signal and then, in an exemplary embodiment, reconstruct the outbound signal as a reference signal. According to one embodiment of the present invention, a reference outbound signal is regenerated from the composite signal by a signal reconstruction module 1803. Alternatively, the outbound signal can be buffered at the hub station 103 to serve as the reference signal (per the transceiver circuitry of FIG. 7).

To achieve accurate interference cancellation, the reconstructed outbound signal is passed through a non-linearity compensation and cancellation module 1805, which iteratively estimates the inbound signal using knowledge of the TWTA response. To reliably recover the inbound signals, the outbound signal has to be cancelled, such that the cancellation accurately accounts for the non-linearity, which stems from the TWTA response. The non-linear characteristics of the TWTA are generated by the TWTA Response Estimator 731 (FIG. 7).

Although the modules 1801, 1803, 1805 are described with respect to individual functionalities, it is recognized that any combination of the modules may be implemented collectively or individually in hardware (e.g., Field Programmable Gate Array (FPGA), Application Specific Integrated Circuit (ASIC), etc.) and/or software.

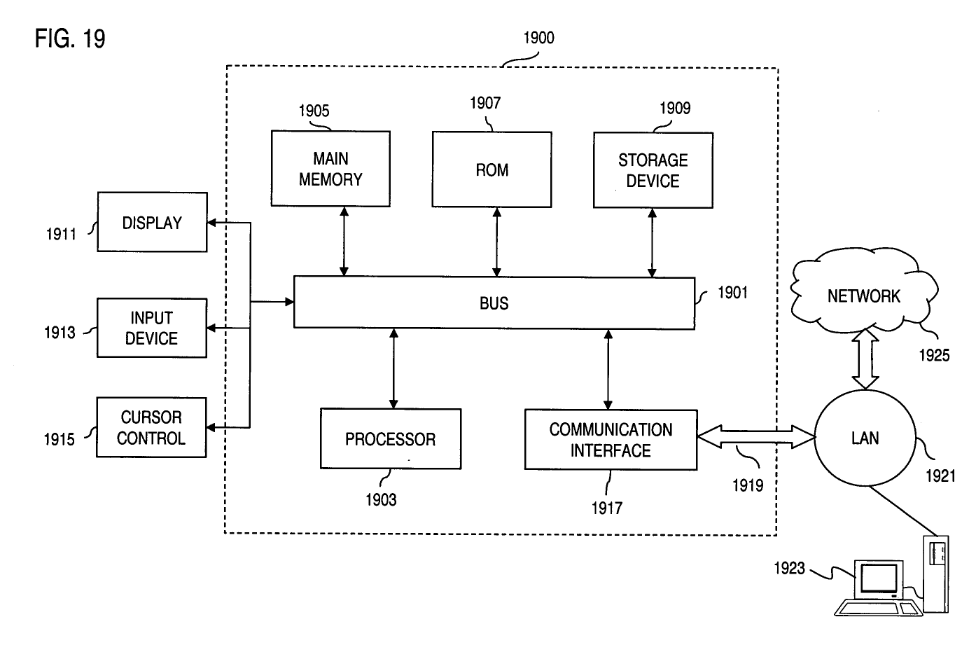

FIG. 19 illustrates a computer system 1900 upon which an embodiment according to the present invention can be implemented. The computer system 1900 includes a bus 1901 or other communication mechanism for communicating information, and a processor 1903 coupled to the bus 1901 for processing information. The computer system 1900 also includes main memory 1905, such as a random access memory (RAM) or other dynamic storage device, coupled to the bus 1901 for storing information and instructions to be executed by the processor 1903. Main memory 1905 can also be used for storing temporary variables or other intermediate information during execution of instructions to be executed by the processor 1903. The computer system 1900 further includes a read only memory (ROM) 1907 or other static storage device coupled to the bus 1901 for storing static information and instructions for the processor 1903. A storage device 1909, such as a magnetic disk or optical disk, is additionally coupled to the bus 1901 for storing information and instructions.

The computer system 1900 maybe coupled via the bus 1901 to a display 1911, such as a cathode ray tube (CRT), liquid crystal display, active matrix display, or plasma display, for displaying information to a computer user. An input device 1913, such as a keyboard including alphanumeric and other keys, is coupled to the bus 1901 for communicating information and command selections to the processor 1903. Another type of user input device is cursor control 1915, such as a mouse, a trackball, or cursor direction keys for communicating direction information and command selections to the processor 1903 and for controlling cursor movement on the display 1911.

According to one embodiment of the invention, the process of FIG. 19 is provided by the computer system 1900 in response to the processor 1903 executing an arrangement of instructions contained in main memory 1905. Such instructions can be read into main memory 1905 from another computer-readable medium, such as the storage device 1909. Execution of the arrangement of instructions contained in main memory 1905 causes the processor 1903 to perform the process steps described herein. One or more processors in a multi-processing arrangement may also be employed to execute the instructions contained in main memory 1905. In alternative embodiments, hard-wired circuitry may be used in place of or in combination with software instructions to implement the embodiment of the present invention. Thus, embodiments of the present invention are not limited to any specific combination of hardware circuitry and software.

The computer system 1900 also includes a communication interface 1917 coupled to bus 1901. The communication interface 1917 provides a two-way data communication coupling to a network link 1919 connected to a local network 1921. For example, the communication interface 1917 may be a digital subscriber line (DSL) card or modem, an integrated services digital network (ISDN) card, a cable modem, or a telephone modem to provide a data communication connection to a corresponding type of telephone line. As another example, communication interface 1917 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1917 sends and receives electrical, electromagnetic, or optical signals that carry digital data streams representing various types of information. Further, the communication interface 1917 can include peripheral interface devices, such as a Universal Serial Bus (USB) interface, a PCMCIA (Personal Computer Memory Card International Association) interface, etc.

The network link 1919 typically provides data communication through one or more networks to other data devices. For example, the network link 1919 may provide a connection through local network 1921 to a host computer 1923, which has connectivity to a network 1925 (e.g. a wide area network (WAN) or the global packet data communication network now commonly referred to as the “Internet”) or to data equipment operated by service provider. The local network 1921 and network 1925 both use electrical, electromagnetic, or optical signals to convey information and instructions. The signals through the various networks and the signals on network link 1919 and through communication interface 1917, which communicate digital data with computer system 1900, are exemplary forms of carrier waves bearing the information and instructions.

The computer system 1900 can send messages and receive data, including program code, through the network(s), network link 1919, and communication interface 1917. In the Internet example, a server (not shown) might transmit requested code belonging to an application program for implementing an embodiment of the present invention through the network 1925, local network 1921 and communication interface 1917. The processor 1903 may execute the transmitted code while being received and/or store the code in storage device 199, or other non-volatile storage for later execution. In this manner, computer system 1900 may obtain application code in the form of a carrier wave.

The term “computer-readable medium” as used herein refers to any medium that participates in providing instructions to the processor 1903 for execution. Such a medium may take many forms, including but not limited to non-volatile media, volatile media, and transmission media. Non-volatile media include, for example, optical or magnetic disks, such as storage device 1909. Volatile media include dynamic memory, such as main memory 1905. Transmission media include coaxial cables, copper wire and fiber optics, including the wires that comprise bus 1901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) and a laptop. An infrared detector on the portable computing device receives the information and instructions borne by the infrared signal and places the data on a bus. The bus conveys the data to main memory, from which a processor retrieves and executes the instructions. The instructions received by main memory may optionally be stored on storage device either before or after execution by processor.

Accordingly, an approach is provided for estimating the response of TWTA for multiuser satellite communication systems. The technique has two stages: a Coarse Estimation stage that can operate in real time, and a Post Processing stage that can operate offline on a block-by-block basis. If the uplink multiuser interference is moderate, a simple MMSE curve-fitting algorithm can be applied in the Post Processing stage. However, if the interference is severe, an iterative algorithm can be applied to remove the estimation bias. This scheme advantageously is robust to the uplink multiuser interference, downlink noise and severe non-linearity, while providing simple implementation—e.g., readily suitable for DSP (digital signal processing) implementations.

While the present invention has been described in connection with a number of embodiments and implementations, the present invention is not so limited but covers various obvious modifications and equivalent arrangements, which fall within the purview of the appended claims.

1. A method of estimating non-linear characteristics of an amplifier used to amplify a composite signal in a radio communication system, the method comprising:
sampling the composite signal that includes a plurality of inbound signals overlay on an outbound signal, wherein the outbound signal is utilized as a training signal;
generating coarse estimates of response of the amplifier based on the samples of the composite signal and the training signal;
removing interference associated with the plurality of inbound signals from the estimation of the response of the amplifier by curve-fitting and estimating interference characteristics of the composite signal; and
outputting an estimated response of the amplifier.

2. A method according to claim 1, further comprising:
storing the outbound signal for use as the training signal.

3. A method according to claim 1, further comprising:
generating the outbound signal for use as the training signal by demodulating the composite signal.

4. A method according to claim 1, further comprising:
filtering the samples to remove noise components according to quantization of input power of the training signal.

5. A method according to claim 1, further comprising:
computing, based on the coarse estimates, amplifier parameters specifying non-linear distortion characteristics associated with the amplifier; and
determining the response of the amplifier based on the amplifier parameters.

6. A method according to claim 1, further comprising:
iteratively performing the removing step according to one of a predetermined number of iterations and satisfying a threshold for estimated noise power associated with the composite signal.

7. A method according to claim 1, wherein the radio communication system includes a plurality of terminals capable of communicating over a satellite housing the amplifier, and the inbound signals are transmitted from the respective terminals to the satellite.

8. A method according to claim 7, wherein the amplifier is a Travelling Wave Tube Amplifier (TWTA).

9. A computer-readable medium bearing instructions for estimating non-linear characteristics of an amplifier used to amplify a composite signal in a radio communication system, the instructions being arranged, upon execution, to cause one or more processors to perform the step of a method according to claim 1.

10. An apparatus for estimating non-linear characteristics of an amplifier operating in a radio communication system, the apparatus comprising:
means for sampling a composite signal that includes a plurality of inbound signals overlay on an outbound signal, wherein the outbound signal is utilized as a training signal;
means for generating coarse estimates of response of the amplifier based on the samples of the composite signal and the training signal;
means for removing interference associated with the plurality of inbound signals from the estimation of the response of the amplifier by curve-fitting and estimating characteristics of the composite signal; and
means for outputting an estimated response of the amplifier.

11. An apparatus according to claim 10, further comprising:
means for storing the outbound signal for use as the training signal.

12. An apparatus according to claim 10, further comprising:
means for demodulating the composite signal to generate the outbound signal for use as the training signal.

13. An apparatus according to claim 10, further comprising:
means for filtering the samples to remove noise components according to quantization of input power of the training signal.

14. An apparatus according to claim 10, further comprising:
means for computing, based on the coarse estimates, amplifier parameters specifying non-linear distortion characteristics associated with the amplifier; and
means for determining the response of the amplifier based on the amplifier parameters.

15. An apparatus according to claim 10, wherein the removing means iteratively removes the interference according to one of a predetermined number of iterations and satisfying a threshold for estimated noise power associated with the composite signal.

16. An apparatus according to claim 10, wherein the radio communication system includes a plurality of terminals capable of communicating over a satellite housing the amplifier, and the inbound signals are transmitted from the respective terminals to the satellite.

17. An apparatus according to claim 16, wherein the amplifier is a Travelling Wave Tube Amplifier (TWTA).

18. A method of compensating for amplifier non-linearity in a radio communication system, the method comprising:
estimating distortion characteristics of an amplifier in real-time based on samples of a received composite signal and a training signal, wherein the composite signal includes a plurality of inbound signals overlay on an outbound signal that is utilized as the training signal;
iteratively curve-fitting to remove uplink interference and downlink interference from the estimates; and
modifying the received composite signal based on the estimates.

19. A method according to claim 18, wherein the radio communication system includes a plurality of terminals capable of communicating over a satellite housing the amplifier, and the inbound signals are transmitted from the respective terminals to the satellite, the amplifier being a Travelling Wave Tube Amplifier (TWTA).

20. A computer-readable medium bearing instructions for compensating for amplifier non-linearity in a radio communication system, the instructions being arranged, upon execution, to cause one or more processors to perform the step of a method according to claim 18.
